(19) United States
(12) Patent Application Publication
(10) Pub. No.: US 2025/0168714 A1
(43) Pub. Date: May 22, 2025

(54) DEVICE AND METHOD FOR MULTI ACCESS PACKET

(71) Applicant: SyncTechno Inc., Seoul (KR)

(72) Inventors: Hyounhee KOO, Seoul (KR); Changho RYOO, Seoul (KR)

(21) Appl. No.: 18/929,915

(22) Filed: Oct. 29, 2024

(30) Foreign Application Priority Data
Nov. 20, 2023 (KR) 10-2023-0160077
Dec. 5, 2023 (KR) 10-2023-0174380

(51) Int. Cl. H04W 36/00; H04W 36/08

(52) U.S. Cl. CPC H04W 36/0033; H04W 36/08

(57) ABSTRACT

Provided is a device that supports Access Traffic Steering, Switching and Splitting (ATSSS) via a multi-access (MA)-packet data unit (PDU) session. The device registers with a 3rd Generation Partnership Project (3GPP) access and registers with a non-3GPP access. The device establishes an MA-PDU session over the 3GPP access and the non-3GPP access. The device transmits a message in the MA-PDU session through the non-3GPP access. The message includes supplementary information relating to a communication status between the wireless device and the 3GPP access.

### CROSS-REFERENCE TO RELATED APPLICATIONS

This application claims the benefit of Korean Patent Application No. 10-2023-0160077 filed Nov. 20, 2023, and No. 10-2023-0174380 filed Dec. 5, 2023, the contents of which are incorporated herein in their entirety.

### BACKGROUND OF THE DISCLOSURE

### Field

The present disclosure relates to a wireless communication, and more particularly to a method and devices for supporting Access Traffic Steering, Switching and Splitting (ATSSS) over a multi-access (MA)-packet data unit (PDU) session in a wireless communication.

### Related Art

The convergence of a 5G system with a non-3rd Generation Partnership Project (3GPP) access network have a major impact in the information and communication technology (ICT) context. The 5G Core Network (5GCN) is designed to be highly flexible due to the adoption of service-based architecture (SBA), network slicing, and software-defined networking (SDN). In addition to the Next Generation-Radio Access Network (NG-RAN), which is based on 5G New Radio (5G NR), the 5GCN is designed to simply and efficiently integrate multiple access networks such as Long Term Evolution (LTE)/4G and Wireless Local Area Network (WLAN).

Integrating a 3GPP access and a non-3GPP access is fundamental to the adoption of 5G Non-Public Networks for vertical domains with heterogeneous access networks. With effective solutions to mitigate data congestion, address capacity, and coverage issues, intelligent integration between the 3GPP access and the non-3GPP access can be useful to address new use cases resulting from the growth of Internet of Things (IoT) devices and industrial communications.

For example, starting with 3GPP's Release 16, the support of a trusted non-3GPP access and a wireline access enables the 5GCN to be used to serve different wireless and wireline access technologies. The integration between the non-3GPP network and the vertical 5G will enable the higher data rate, increased regional capacity, lower latency, and improved localization.

Access Traffic Steering, Switching and Splitting (ATSSS) is being standardized by the 3GPP and allows traffic steering across multiple accesses. ATSSS provides network support for steering a transmission path, switching traffic from one path to another, and splitting multiple paths simultaneously.

WLAN (or Wi-Fi) has mainly considered as the non-3GPP access when the non-3GPP access is integrated with the 3GPP access. However, depending on the use case, there is a need to integrate more diverse non-3GPP accesses with the 3GPP access.

### SUMMARY OF THE DISCLOSURE

This disclosure provides a method and device for supporting Access Traffic Steering, Switching and Splitting (ATSSS) over a multi-access (MA)-packet data unit (PDU) session.

In an aspect, a method for a communication that supports Access Traffic Steering, Switching and Splitting (ATSSS) via a multi-access (MA)-packet data unit (PDU) session is provided. The method performed by a wireless device includes registering with a 3rd Generation Partnership Project (3GPP) access, registering with a non-3GPP access, establishing an MA-PDU session over the 3GPP access and the non-3GPP access, and transmitting a message in the MA-PDU session through the non-3GPP access, the message including supplementary information relating to a communication status between the wireless device and the 3GPP access.

In another aspect, a device for supporting Access Traffic Steering, Switching and Splitting (ATSSS) via a multi-access (MA)-packet data unit (PDU) session is provided. The device includes a processor, and a memory operatively coupled with the processor and configured to store instructions that, when executed by the processor, cause the device to perform functions. The functions include registering with a 3rd Generation Partnership Project (3GPP) access, registering with a non-3GPP access, establishing an MA-PDU session over the 3GPP access and the non-3GPP access, and transmitting a message in the MA-PDU session through the non-3GPP access, the message including supplementary information relating to a communication status between the wireless device and the 3GPP access.

Although there are differences in transport specifications between a 3GPP access and a non-3GPP access, the two accesses can be integrated to support ATSSS.

A non-3GPP access that does not support any secure connection can be integrated with the 3GPP access to support ATSSS.

### BRIEF DESCRIPTION OF THE DRAWINGS

FIG. 1 illustrates an example of a 5G system architecture in which embodiments of the present disclosure are implemented.

FIG. 2 illustrates an example of a 5GCN system architecture with a non-trusted 3GPP access network.

FIG. 3 shows CP protocol stack before IPSec SA signaling.

FIG. 4 shows CP protocol stack after IPSec SA signaling.

FIG. 5 shows UP protocol stack for transporting user traffic.

FIG. 6 shows an example of an access procedure for an untrusted non-3GPP access network.

FIG. 7 shows an example of the PDU session establishment procedure for a non-3GPP access network.

FIG. 8 shows an example of a procedure for establishing an MA-PDU session.

FIG. 9 illustrates an MA-PDU based communication method according to an embodiment of the present disclosure.

FIG. 10 illustrates a method for ensuring security according to one embodiment of the present disclosure.

FIG. 11 shows an example of a message structure according to the VDES standard.

FIG. 12 is a block diagram illustrating wireless devices in which embodiments of the present disclosure are implemented.

### DETAILED DESCRIPTION OF THE EMBODIMENTS

A user equipment (UE) is a wireless device that communicates with a base station and may be referred to as a mobile terminal (MT), mobile station (MS), advanced mobile station (AMS), high reliability mobile station (HR-MS), subscriber station, portable subscriber station, access terminal, etc. The UE may be mounted or installed on a variety of application devices, such as laptops, vehicles, ships, consumer electronics, and the like, to perform communication functions in accordance with embodiments of the present disclosure.

A base station (BS) is a radio device that communicates with a UE and may be referred to as an advanced base station (ABS), high reliability base station (HR-BS), node B, evolved node B (eNodeB), gNodeB, access point (AP), radio access station (RAS), and the like. The BS may be fixed or mobile deployed on the ground or may include a satellite.

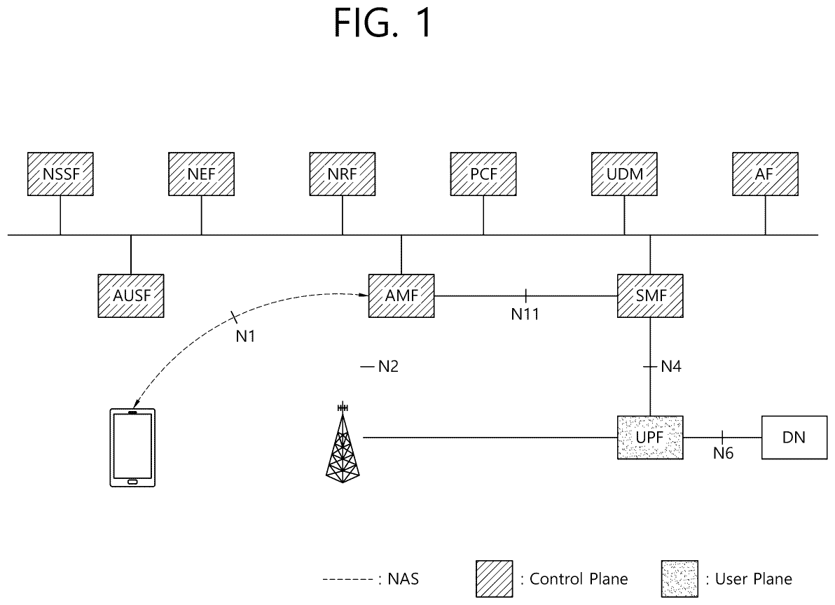

FIG. 1 illustrates an example of a 5G system architecture in which embodiments of the present disclosure are implemented.

A 5G system includes a Radio Access Network (RAN) and a Core Network (CN). The 5G Core Network (5GCN) is a set of Network Functions (NFs) that provide the expected core functions. Each NF acts as a service producer, exposing services to other NFs. As consumers, a NF can use services provided by a peer NF. These functions expose and make services available and are characteristic of a service-based interface (SBI).

For core access and mobility management, an UE can select services offered by NFs in the 5GCN. The UE needs to establish a transport session for data transfer and maintain continuous communication with the 5GCN for several control and management tasks. The Non-Access Stratum (NAS) protocol is used to control the message exchange between the UE and the 5GCN.

Examples of NFs are Access and Mobility Function (AMF), Session Management Function (SMF), User Plane Function (UPF), Authentication Server Function (AUSF), Network Slice Selection Function (NSSF), Network Exposure Function (NEF), Network Repository Function (NRF), Policy Control Function (PCF), Unified Data Management (UDM), Application Function (AD), etc. NFs related to non-3GPP access are described later.

The AMF in the Control Plane (CP) is responsible for mobility management with possible handovers of users. The SMF is responsible for maintaining existing sessions. AUSF and UDM are standardized to generate and manage authentication keys to perform UE authentication and authorization. The NSSF, NEF, NRF, PCF, and AF also belong to the CP and are responsible for various control and management tasks. The UPF in the user plane (UP) forwards traffic between the UE and the data network (DN). The SMF also instructs the UPF to generate packet detection and forwarding rules. To utilize services provided by the mobile network operator (MNO), the UE connects to the RAN through an air interface and requests NAS signaling for the AMF and PDU session settings. For example, NFs can communicate with each other on the SBI via Hypertext Transfer Protocol (HTTP) and Transport Layer Security (TLS) for secure connectivity.

NAS signaling between the UE and AMF is performed over N1 interface. N2 interface is a point-to-point communication between the BS and the AMF for sending session management messages. N3 interface is used for packet exchange between the base station and UPF, and N11 interface is used for AMF and SMF interaction. N4 interface is used by the SMF to transmit and forward packet detection rules to the UPF. N6 interface connects the UPF and the DN.

An NF that generates information in the Public Land Mobile Network (PLMN) provides mobile services to UEs connected to a 3GPP access network and/or a non-3GPP access network. When roaming, the NF may also provide services to UEs outside the HPLMN. Roaming may allow the UE to use mobile services outside the coverage area or in a Visited Public Land Mobile Network (VPLMN).

To support UE connectivity over non-3PP access networks, there are three access types: (i) untrusted, (ii) trusted, and (iii) wireline.

Untrusted access means that the MNO does not trust the security provided by the non-3GPP access network. therefore, the MNO needs to transport traffic by using a secure option. The NF to support the untrusted access network is the Non-3GPP Interworking Function (N3IWF). The basic idea of the N3IWF, introduced in 3GPP Release 15, is to act as a gateway for communication between the UE and the 5GCN.

Trusted access indicates that the operator has full control over a trusted non-3GPP access point (TNAP) and radio link access. Therefore, the operator controls encryption or has confidence in the security provided by the non-3GPP access network. The Trusted Non-3GPP Gateway Function (TNGF) exposes N2 and N3 interfaces to allow the UE to connect to the 5GCN over the trusted access network.

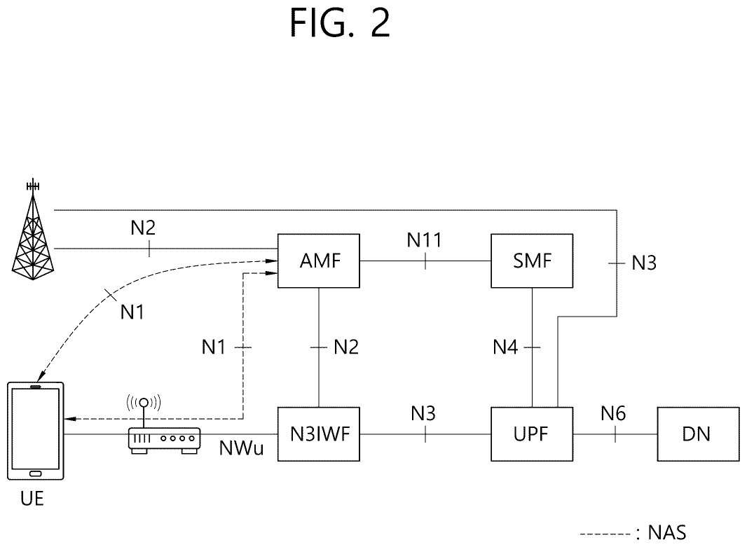

FIG. 2 illustrates an example of a 5GCN system architecture with a non-trusted 3GPP access network.

The major NF in the non-trusted non-3GPP access network is the N3IWF, which provides a secure connection to the UE in order to access the 5GCN via the CP/UP functions. The N3IWF connects with the AMF via the N2 interface in the CP. For data traffic in the UP, the N3IWF connects to the UPF via the N3 interface. After completing the authentication and authorization process, the non-3GPP device connects to the 5GCN through the non-3GPP in access network and performs NAS signaling through the N1 interface. The data packet transmission between the UE and the DN uses a secure IP Security (IPSec) tunnel between the UE and the N3IWF. In addition, the General Packet Radio Services Tunnelling Protocol for User Data (GTP-U) establishes a tunnel between the N3IWF and the UPF.

The N3IWF can support at least one of the following features.

(1) IPSec tunnel setup. The UE creates an IPSec tunnel (referred to as NWu) using the Extensible Authentication Protocol (EAP) method over Internet Key Exchange Version 2 (IKEv2) and IPSec protocols (e.g., Generic Routing Encapsulation (GRE), Encapsulation Security Payload (ESP)).

(2) Enable the IPSec tunnel. Secure NAS messages for CP and protect data traffic for UP.

(3) Set up the N2 interface with Next-Generation Application Protocol (NGAP) and Stream Control Transmission Protocol (SCTP) for the CP. N3 interface setup with GTP-U for UP.

(4) Uplink and downlink relay. NAS N1 signaling messages between UE and AMF and UP packets between UE and UPF.

(5) Encapsulation and decapsulation of packets for IPSec and N3 tunneling.

(6) Processing of N2 signaling from SMFs relayed by AMFs related to UP data traffic management sessions, etc.

(7) AMF selection. Transparent forwarding of messages from the UE to the AMF.

As shown in FIG. 2, untrusted non-3GPP access interworking involves simultaneous connectivity of two access networks: 3GPP access via gNodeB and non-3GPP access via N3IWF. A single AMF serves UEs connected via 3GPP access and non-3GPP access due to its non-roaming architecture. Multiple N1 instances are created for traffic differentiation (e.g., a first N1 instance via gNodeB and a second N1 instance via N3IWF). In both 3GPP and non-3GPP access, the NAS protocol forms the top-level CP between the UE and the AMF, and SCTP is used to secure the transport of the exchanged messages. Both the gNodeB and the N3IWF connect to the UPF encapsulated within GTP-U tunneling via the N3 interface.

Table 1 shows the communication interfaces and protocols involved for 3GPP access and untrusted non-3GPP access.

TABLE 1

| Access Type | Interface | Source | Destination | Protocol |
|---|---|---|---|---|
| 3GPP access | N1 | UE | AMF | NAS |
| Non-3GPP access | N1 | UE | AMO | NAS |
| 3GPP access | N2 | gNodeB | AMF | NGAP & SCTP |
| Non-3GPP access | N2 | N3IWF | AMF | NGAP & SCTP |
| 3GPP access | N3 | gNodeB | UPF | GTP-U |
| Non-3GPP access | N3 | N3IWF | UPF | GTP-U |

An example of a non-trusted non-3GPP access includes a non-trusted wireless local area network (WLAN) (referred to as WLAN or Wi-Fi). The authentication process and authorization to use data services of the UE to access the 5GCN over a non-trusted WLAN may be provided by different protocols in the CP and UP. There are protocols involved in different stages of the UE's interaction with the 5GCN, such as initial access, pre-registration, data user transport port setup, etc.

The standardized CP and UP protocols for untrusted access depend on the permission obtained by the UE from the core network. The initial access to the 5GCN is considered as a first contact of the UE and is performed before IPSec signaling because there is no secure tunnel between the UE and the N3IWF. After registration or IPSec security association (SA) establishment, the UE can request PDU session establishment to the AMF using the IPSec tunnel created in NAS signaling.

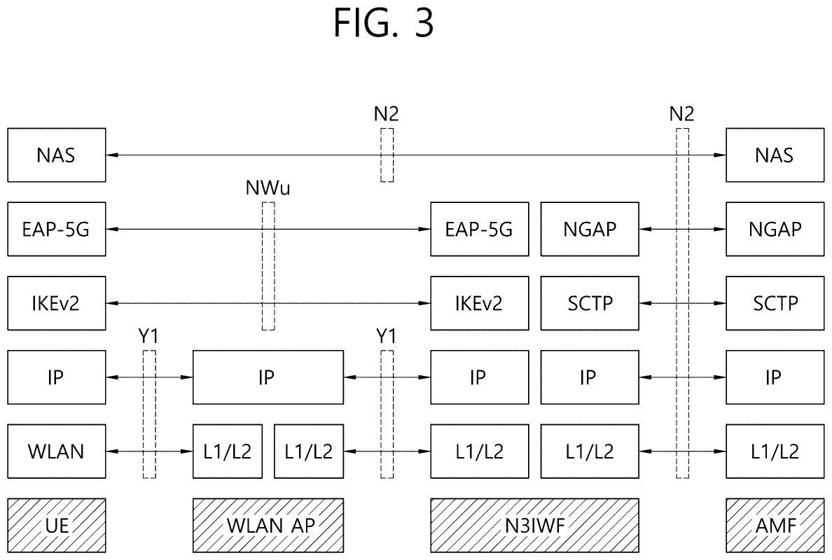

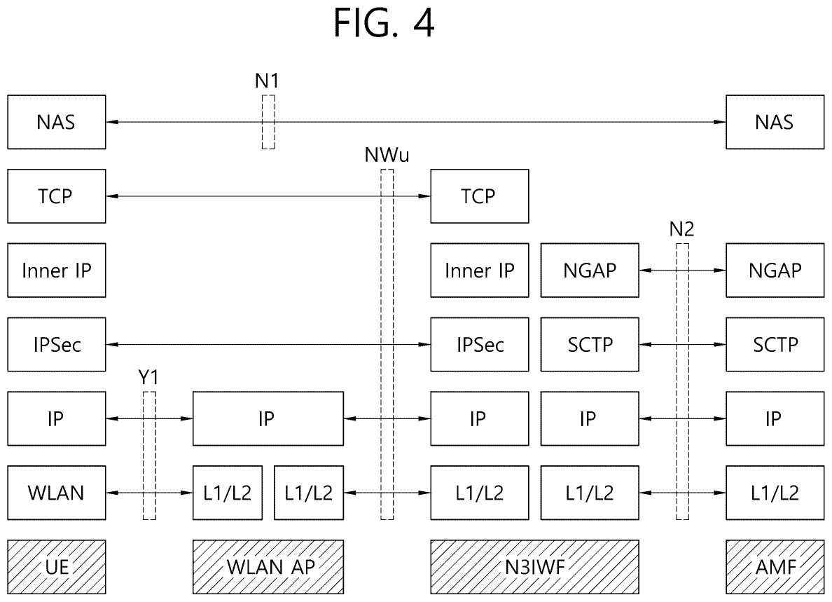

FIG. 3 shows CP protocol stack before IPSec SA signaling. FIG. 4 shows CP protocol stack after IPSec SA signaling. A WLAN AP is utilized as an example of non-trusted non-3GPP access.

NAS messages to provide communication between the UE and the N3IWF use EAP-5G/IKEv2. After the IPSec SA is established, the UE establishes a Transmission Control Protocol (TCP) connection with the N3IWF to send NAS messages and session management messages over the Internet Protocol (IP) layer and IPSec tunnel. The AMF can adopt same CP protocol stack to communicate with the N3IWF before and after IPSec SA signaling (e.g., SCTP and NGAP over N2 interface). To communicate with the UE, the AMF uses the NAS protocol to encapsulate messages over the N1 interface.

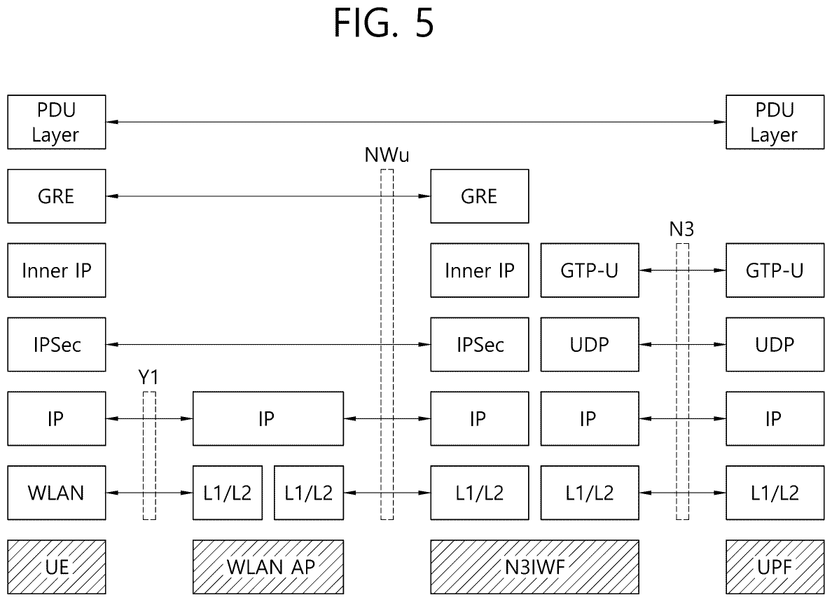

FIG. 5 shows UP protocol stack for transporting user traffic. The PDU layer corresponds to the data passed between the UE and the DN.

Before sending UP traffic, the PDU session is encapsulated as a Generic Routing Encapsulation (GRE) packet. The established child SA uses IPSec tunnel mode to encrypt and protect the original IP user data packets and the used port numbers. An end-user PDU from the UE is encapsulated via GTP-U when the end-user PDU arrives at the N3IWF before reaching the UPF. The UP in 5G systems is operated based on GTP-U as in LTE/4G, and tunnels user traffic to the CN's anchor point. GTP-U runs on top of the User Datagram Protocol (UDP), which allows many applications to be used on multiple ports with the same IP address.

For a non-trusted non-3GPP access network to access a 3GPP access network, the following procedures are required: (i) network discovery and selection, (ii) registration, authentication and authorization, and (iii) PDU session establishment. This subsection provides information on how a UE discovers and selects an untrusted non-3GPP access network, is authenticated to access the 5GCN and is authorized to use data services via UPF.

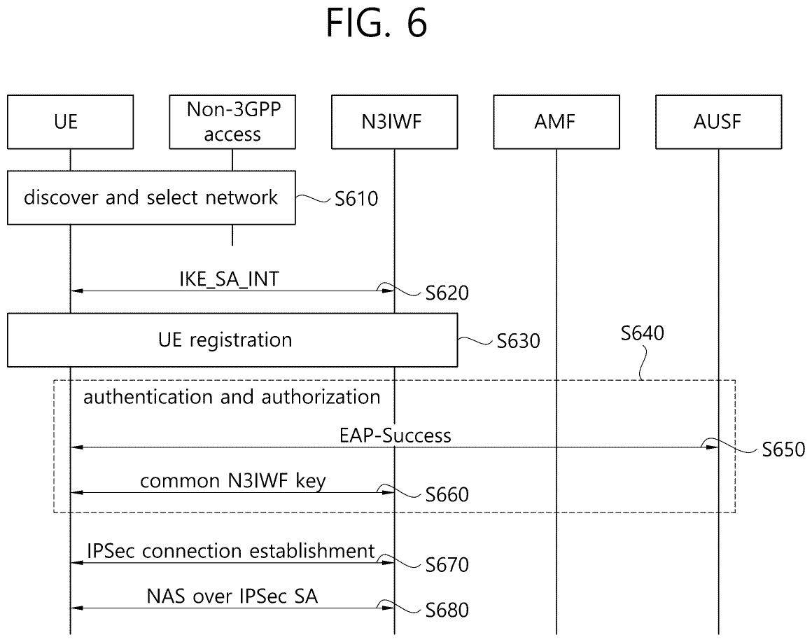

FIG. 6 shows an example of an access procedure for an untrusted non-3GPP access network.

In step S610, for network discovery and selection, the UE may use the Access Network Discovery and Selection Policy (ANDSP) to discover and prioritize non-3GPP access networks. The UE may select a non-3GPP access network to obtain an IP address.

For registration over non-trusted non-3GPP access networks, a vendor specific EAP method called EAP-5G is adopted. This method is used for NAS message encapsulation over the IKEv2 protocol between the UE and the N3IWF. For example, the UE can use a WLAN AP to connect to a non-trusted non-3GPP access network. For example, the UE on the WLAN obtains an IP address. The UE selects N3IWF from the PLMN.

In step S610, the first message exchanged between the UE and the untrusted non-3GPP access network, and subsequently between the UE and the N3IWF, can be represented as plain texts without security protection. The UE starts the initial procedure with IKE_SA_INIT, which enables encryption and integrity protection for all subsequent IKEv2 messages (step S620).

In step S630, the UE performs registration based on IKEv2 using the NAS message encapsulated with EAP-5G. The initial IKE_Auth request message from the UE to the N3IWF has no payload, and the N3IWF interprets it as an EAP-5G session start request. The N3IWF responds with an IKE_Auth message containing an EAP-Request/5G-Start packet. This packet informs the UE to start the EAP-5G session, i.e., to start sending NAS messages. The UE sends a registration request message containing an EAP-Response/5G-NAS. This IKE_Auth response contains access network parameters that the N3IWF uses for the AMF selection process.

In step S640, after selecting the AMF, the UE is authenticated by calling the AUSF. A UDM is selected to obtain the authentication data, and EAP-AKA or 5G-AKA authentication is performed. Upon completion of step S640, the UE can derive the anchor key, NAS and N3IWF keys. At this point, the EAP-5G session is complete and no further EAP-5G messages are exchanged.

In step S650, after successful authentication, the AUSF encapsulates a Security Anchor Function (SEAF) key with EAP-SUCCESS and sends the SEAF key to the AMF. From this, the AMF and UE can derive two keys for NAS security and N3IWF security. In step S660, the common standard security key (i.e., the N3IWF key) is derived from the anchor keys provided by the AUSF, UE, and N3IWF.

In step S670, the IPSec connection establishment, called IPSec SA, is performed using the N3IWF key. In step S680, after the registration, authentication, and authorization procedures are completed, NAS messages for the registration completion, authentication, and authorization procedures are sent over the IPSec SA. At this point, the UE is ready to start establishing a PDU session for data communication.

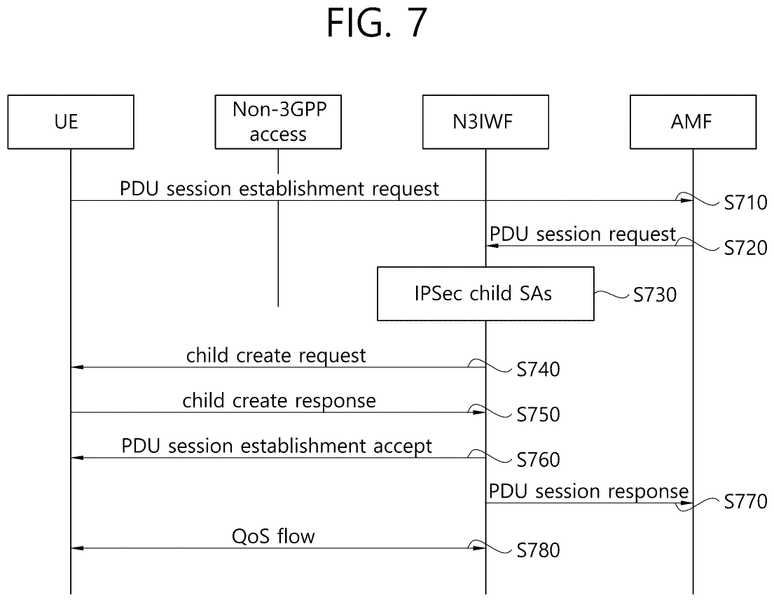

FIG. 7 shows an example of the PDU session establishment procedure for a non-3GPP access network.

Both the UE and the network can initiate PDU session establishment. The UE may initiate PDU session procedures for new session establishment and handover. For handover, the UE may initiate a PDU session for handover between 3GPP access and non-3GPP access networks (e.g., 5G and WLAN) or handover between 5G and Evolved Packet Core (EPC).

In step S710, the UE sends a PDU session establishment request to the AMF via the IPSec SA for NAS signaling. The AMF relays the request message according to the roaming context. Typically, the AMF selects the SMF to create the PDU session context.

In step S720, after authorization of the PDU session between the UE and the DN, the AMF sends a PDU session request message to the N3IWF. In step S730, the N3IWF determines the number of IPSec child SAs that are created for the association of each QoS profile based on the policy and quality of service (QOS) profile transmitted by the UE.

In step S740, the N3IWF sends an Internet Key Exchange (IKE) message to the UE to generate a request for the creation of the first IPSec child. In step S750, after the UE's response, additional IPSec SAs can be created if necessary.

In step S760, when all IPSec SAs are established, a PDU session establishment acknowledgment is sent from the N3IWF to the UE via the signaling IPSec SA. In step S770, the N3IWF sends a PDU session response containing the GTP-U tunnel to the AMF. In step S780, the QoS flow is sent inside the IPSec child SA previously created by the N3IWF request.

The PDU session between the UE and the N3IWF is encapsulated inside the GRE tunnel. The UE encapsulates the GRE packet into an IP packet that contains the source address, the internal IP of the UE, and the destination IP address associated with the IPSec child SA. When the N3IWF receives a PDU over the N3 interface, the N3IWF encapsulates this PDU as a GRE packet and verifies the identity (ID) of the PDU session to use the correct IPSec child SA. Finally, the N3IWF encapsulates the GRE packet into an IP packet that contains the source IP address, the associated IPSec child SA, and the destination internal IP address of the UE.

A UE simultaneously registered to a 3GPP access and a non-trusted non-3GPP access can have multiple PDU sessions for both accesses, with each PDU session active in only one of the accesses. When the UE enters into an idle mode in one of the accesses, the UE may move a PDU session in the idle access to the target access according to the UE policy. The UE may initiate the registration procedure in the target access for the handover and then start the PDU session setup using the PDU session ID of the moved PDU session.

3GPP Release 16 supports Access Traffic Steering, switching and splitting (ATSSS) which enables a Multi-Access (MA)-PDU session. According to the MA-PDU session, a PDU session with multiple packet flows may steer 3GPP access or non-3GPP access for each packet flow, the packet flow may be switched between 3GPP access and non-3GPP access, or the packet flow may be split between 3GPP access and non-3GPP access.

The MA-PDU session may be established through two PDU session establishment procedures. For example, the UE may perform a PDU session establishment procedure to establish an MA-PDU session over 3GPP access, and then the UE may add the non-3GPP access to the MA-PDU session created over the 3GPP access.

An MA-PDU session may be established for 3GPP and non-3GPP access simultaneously via a single procedure. This single procedure can be referred to as the UE requested MA-PDU session establishment procedure. The above procedure may be useful if the UE wants to establish an MA-PDU session while the UE is already registered in the 5G system with the two accesses.

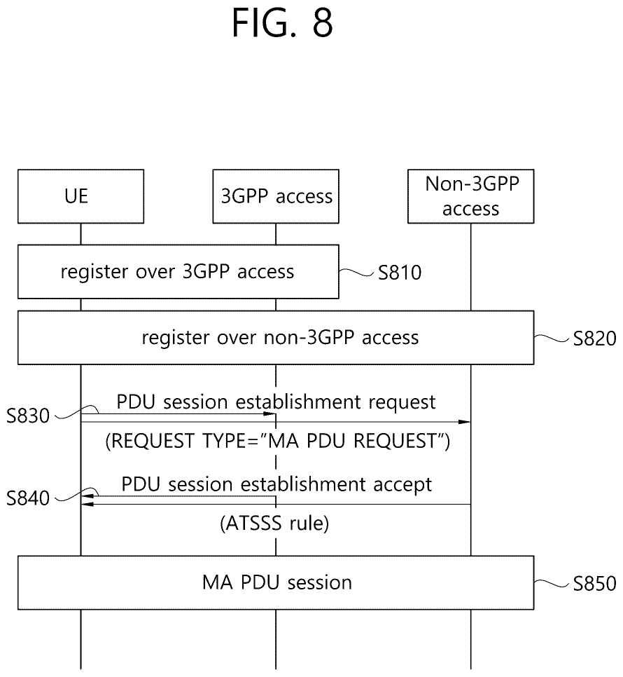

FIG. 8 shows an example of a procedure for establishing an MA-PDU session.

In step S810, the UE registers to the 5G system network with 3GPP access. In step 820, the UE registers with the 5G system network on the non-3GPP access.

In step S830, the UE initiates the PDU session establishment procedure by sending a PDU session establishment request message over one of the two access networks. The message may include a request type set to “MA-PDU request” and a PDU session ID. In step S840, the UE receives a PDU session establishment accept message via its access network. This message may include an ATSSS rule. Accordingly, an MA-PDU session is established between the UE and the 5G system for both 3GPP access and non-3GPP access (step S850).

The ATSSS rule provides parameters for traffic coordination, switching and splitting functions between 3GPP and non-3GPP access. The ATSSS rules may be provided as various messages in the network (e.g., PDU SESSION ESTABLISHMENT ACCEPT, PDU SESSION MODIFICATION COMMAND, etc.). The parameters in the ATSSS rule may include at least one of the following: a rule priority that determines the order in which the ATSSS rule is evaluated at the UE, a traffic descriptor, an application descriptor that identifies the application generating the traffic, an IP descriptor that identifies the destination of the IP traffic, an access selection descriptor, and a steering mode that is applied to the matched traffic.

The steering mode can be set to any one of the following modes.

(1) Active-Standby: Active-Standby can be used to steer service data flow (SDF) from one active access. Then, when the active access becomes unavailable, the SDF switches to another available standby access. When the active access becomes available again, the SDF can switch back to the active access. If no standby access is defined, SDFs are only allowed on the active access and cannot be sent to any other access.

(2) Smallest Delay: Smallest Delay may be used to steer SDFs to the access determined to have the smallest round-trip time (RTT). To determine the RTT over 3GPP access and non-3GPP access, RTT measurements may be performed by the UE and UPF.

(3) Load-Balancing: Load-balancing may be used to split the SDF over both accesses, if both accesses are available. The load-balancing may include a split percentage of SDF traffic sent over 3GPP access and non-3GPP access.

(4) Priority-based: Priority-based can be used to steer traffic in the SDF to higher priority accesses. It can be used to steer traffic from SDFs to high priority access until the high priority access is determined to be congested. If the high priority access is determined to be congested, traffic from the SDF can also be sent to the lower priority access, meaning that the SDF traffic can be split between the two accesses. Alternatively, if the high priority access becomes unavailable, all SDF traffic may be switched over the lower priority access. How the UE and UPF determine when congestion occurs on an access may vary depending on the implementation.

In the context of the convergence of 3GPP and non-3GPP accesses under 5G systems, Wi-Fi is typically considered as an example of non-3GPP access. However, considering that next-generation communication systems will be applied in various fields such as aviation and maritime communication, it is necessary to consider other communication systems other than Wi-Fi as non-3GPP access.

The table 2 shows specifications for various communication systems.

TABLE 2

| Access | Comm. | | | | | Max. | | Trans. | |
|---|---|---|---|---|---|---|---|---|---|
| Type | System | Spectrum | | Bandwidth | | Bitrate | | Range | |
| 3GPP | LTE/4G | 450 MHz~3.7 GHz | | 1.4 MHz~20 MHz | | 75/300 Mbps | | <2 | Km |
| Access | | | | | | for UL/DL | | | |
| | 5G mmW | 24~86 | GHz | | | 20 | Gbps | | |
| Non-3GPP | Wi-Fi | 2.4/5 | GHz | 20/40 | MHz | 600 | Mbps | <100 | m |
| Access | 802.11p | 5.9 | GHz | 10 | MHz | 27 | Mbps | <1 | km |
| | VHF | 30~300 | MHz | 25 | kHz | 307 | kbps | <85 | km |

| | | | | | | | |
|---|---|---|---|---|---|---|---|
| HF | 3~30 | MHz | 48 | KHz | 240 | kbps | Hundreds of |
| | | | | | | | kilometers |

Wi-Fi's maximum bitrate is not significantly different compared to that of 3GPP access (e.g., 4G/5G systems). Therefore, it is possible for the UE to selectively use one of the non-3GPP access and the 3GPP access according to the steering mode described above. However, very high frequency (VHF) system or high frequency (HF) system has a wider transmission range compared to 3GPP access, but the maximum bit rate is only about 1/1000 of the maximum bit rate of the 3GPP access.

VHF/HF system is often used for maritime communications such as automatic identification system (AIS) and/or VHF Data Exchange System (VDES) due to its wide transmission range. If a 3GPP-based communication system is to be integrated with the existing maritime communication system, it is necessary to consider VHF/HF system as non-3GPP access to be integrated into the 3GPP access.

In the existing maritime communication systems, VHF system is used to transmit a ship's position and other information. However, with the introduction of autonomous ship or remotely controlled ship, the data requirements for transmission are expected to increase significantly.

For example, sensor information is one of key information that must be transmitted while a ship is sailing or a vehicle is traveling. The sensor information can include information obtained by scanning the ship's environment, such as infrared cameras, LiDAR, GPS data, etc. The table 3 summarizes requirements for data transmission.

TABLE 3

| | Single | Update | Bitrate |
|---|---|---|---|
| Data Type | File (kB) | period (Hz) | (kbps) |
| Video | 200~500 | 1~10 | 150~1,500 |
| High-resolution | 2600 | 2 | 800~1,500 |
| video | | | |
| LiDAR sensor | ~200,000 | 1 | 1,000~2,000 |
| Infrared camera | 330 | 1~10 | 300~10,000 |
| Mechanical Sensor | 12 | 0.1~1 | 1~10 |
| GPS data | | | 10 |

Since not only single data type but also multiple data type can be required to be transferred, it can be expected that a transmission rate of at least 6 Mbps is required. In addition to the transmission rate, the latency also needs to be considered in order to predict collision avoidance. The 3GPP access can satisfy the required transmission rate and latency, but VHF systems as the non-3GPP access cannot. The 3GPP access cannot replace the VHF system for the maritime communications since the VHF system has wider coverage and has deployed earlier.

The MA-PDU session for the existing ATSSS was established on the assumption that the basic specifications of the 3GPP access and the non-3GPP access are not significantly different and can be used interchangeably. There is a need to integrate a non-3GPP access into a 3GPP access where the specifications of the 3GPP access and the non-3GPP access differ significantly and are not interchangeable.

The following embodiments propose to use the non-3GPP access integrated into the 3GPP access to support ATSSS for ancillary transport for the 3GPP access.

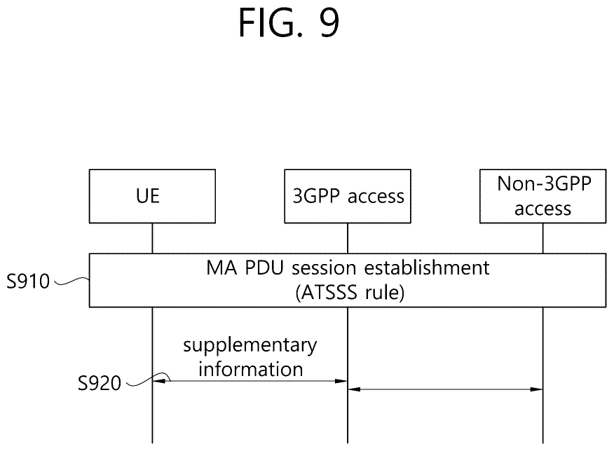

FIG. 9 illustrates an MA-PDU based communication method according to an embodiment of the present disclosure.

In step S910, the UE establishes an MA-PDU session with the non-3GPP access and the 3GPP access. The procedure shown in FIG. 8 may be an example of this establishment procedure.

Before and after establishing the MA-PDU session, the ATSSS rule may be set or changed. The steering mode within this ATSSS rule may be set to one of Active-Standby, Smallest Delay, Load-Balancing, and Priority-based, or it may be set to a new steering mode. For example, the new steering mode, also referred to as unsymmetric mode or biased mode, can utilize two access simultaneously: 3GPP access for primary UL/DL transmission and non-3GPP access for UL/DL transmission for supplementary information.

In step S920, the UE may receive or transmit DL supplementary information and/or UL supplementary information over the non-3GPP access. The UE may receive or transmit most of the traffic information over the 3GPP access. The UE may receive or transmit a predetermined amount of traffic information over the non-3GPP access. The supplementary information may correspond to the predetermined amount of traffic information. The supplementary information may include a traffic on the CP, but not traffic on the UP. The non-3GPP access may forward the received UL supplementary information to the 3GPP access and the 3GPP access can improve the reliability of communication between the UE and the 3GPP access. The UL supplementary information may be transmitted periodically. Alternatively, the UL supplementary information may be transmitted upon a request from the non-3GPP access or the 3GPP access.

The UE may receive DL supplementary information from the non-3GPP access periodically or aperiodically. For example, if the non-3GPP access has a much larger transmission range than the 3GPP access, broadcast data to be transmitted over a wide area may be forwarded by the 3GPP access to the non-3GPP access, and then the non-3GPP access can transmit the broadcast data as supplementary information.

DL/UL supplementary information can include pre-configured information between the 5G system and the UE as a limited amount of traffic.

UL supplementary information can include status information related to the communication status between the UE and the 3GPP access.

The status information may include information regarding the availability and/or unavailability of the 3GPP access. The status information may include an available time duration of the 3GPP access and/or location information corresponding to the available time duration. The status information may include an unavailable time duration of the 3GPP access and/or location information corresponding to the unavailable time duration. The UE may measure the communication quality of the 3GPP access to estimate the availability or unavailability of the 3GPP access. Since the non-3GPP access has a wider transmission range than the 3GPP access, the UE may inform the 3GPP access in advance whether the 3GPP access is available or unavailable over the non-3GPP access. The 3GPP access may suspend to transmit any packet to the UE while the communication between the UE and the 3GPPaccess is unavailable.

The status information may include information regarding a time duration and/or location for the communication quality between the 3GPP access and the UE. The status information may include information regarding a time duration and/or location during which the UE expects that the quality of communication with the 3GPP access is lowered. In addition to measuring the quality of communication with the 3GPP access, the UE may scan the environment around the UE to predict the future quality of communication with the 3GPP access. For example, if the UE is a vessel, the UE may consider the distance between a terrestrial BS for 3GPP access along the sailing route to predict a time duration and/or a location where the quality of communication will be lowered (or time duration and/or location where the quality of communication will be improved).

The VHF system are based on the AIS/VDES standard, which is widely used for maritime communications. For example, the VDES standard can be found in “G1139 THE TECHNICAL SPECIFICATION OF VDES”, published in June 2019 by the INTERNATIONAL ASSOCIATION OF MARINE AIDS TO NAVIGATION AND LIGHTHOUSE AUTHORITIES (IALA). The AIS/VDES standard does not use authentication or integrity checks. The receiver has no way to verify the content of an AIS/VDES message. However, it will be appreciated that authentication and authorization procedures are required to integrate the untrusted non-3GPP access, such as AIS/VDES where authentication is not used, into a 5G system (or next generation 6G system).

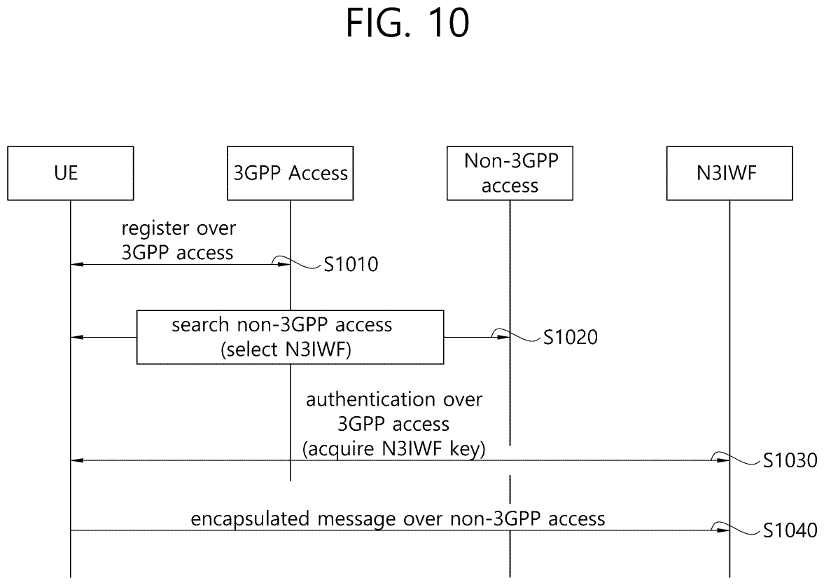

FIG. 10 illustrates a method for ensuring security according to one embodiment of the present disclosure.

In step S1010, the UE performs registration over a 3GPP access. The UE can register with the 5G system network (or a next generation 3GPP network) over the 3GPP access.

In step S1020, the UE discovers a non-3GPP access and selects the N3IWF associated with the non-3GPP access. The UE may obtain the N3IWF identity.

In step S1030, the UE performs authentication over the 3GPP access. The UE may communicate with the N3IWF over the 3GPP access to obtain a security key (i.e., the N3IWF key). According to the procedure in FIG. 6, the security key is obtained over non-3GPP access. In contrast, according to the embodiment of the present disclosure, the security key for non-3GPP access is obtained over the 3GPP access after the N3IWF is selected. Based on the N3IWF key, the UE may then perform the remaining authentication and authorization procedures via the 3GPP access and/or the non-3GPP access.

In step S1040, the UE may transmit an encapsulated message over the non-3GPP access. Part or all of the encapsulated message may be encrypted based on the obtained N3IWF key. It is difficult to encrypt the entire message if the non-3GPP access does not support encryption such as IPSec. The UE may encrypt and transmit a portion of the header and/or payload of a message for the non-3GPP access.

The encapsulated message may include the supplementary information. The supplementary information can be encrypted based on the N3IWF key.

The UE may register to the 5G system network over the 3GPP access and the non-3GPP access. The UE may initiate an MA-PDU session establishment procedure by sending a PDU session establishment request message over 3GPP access. The PDU session establishment request message may include a request type set to “MA-PDU request” and a PDU session ID.

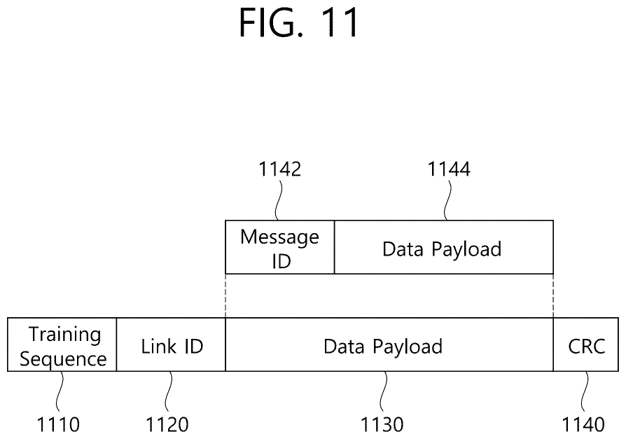

FIG. 11 shows an example of a message structure according to the VDES standard.

A training sequence 1110 includes a sequence used for synchronization. A Link ID 1030 is used for channel setup. A cyclic redundancy check (CRC) 1150 includes a sequence of 32-bit or 16-bit CRC checks. A data payload 1140 includes a message ID 1042 and a data payload 1144 (or sub-data payload).

A message ID 1142 identifies the message type, and according to the existing VDES standard, there are six message types, as follows

TABLE 4

| Message | |
|---|---|
| ID | Message Type |
| 1 | Scheduled broadcast message |
| 2 | Broadcast message |
| 3 | Scheduled individually addressed message |
| 4 | Individually addressed message (require a response of a |
| | receiver) |
| 5 | A response message to the individually addressed message |
| 6 | Geographic multicast message |

For example, the data payload 1144 in the data payload 1140 may be encrypted based on the security key (e.g., the N3IWF key). The data payload 1144 in the data payload 1140 may include the encrypted supplementary information. An additional message type may be defined to indicate the encrypted encapsulated message. For example, message ID 7 may represent an encapsulated scheduled individually addressed message, and message ID 8 may represent an encapsulated individually addressed message. Upon receiving the encapsulated message, the non-3GPP access may forward the message to the core system via the N3IWF.

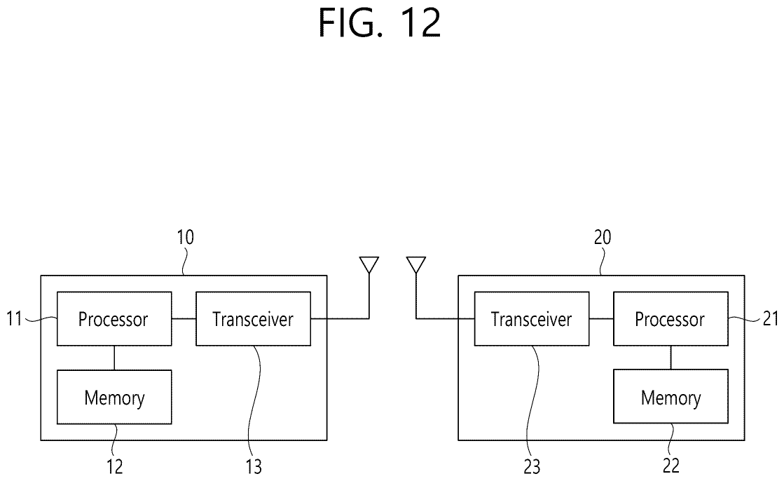

FIG. 12 is a block diagram illustrating wireless devices in which embodiments of the present disclosure are implemented.

A first wireless device 10 may implement the operation of the UE described above. The operations of the first wireless device 10 may be processed by a processor 11. The operations of the UE described herein may be stored in a memory 12 in the form of instructions/programs executable by the processor 11. The processor 11 may control the memory 12 and the transceiver 13, and execute the instructions/programs stored in the memory 12 to perform the operations of the UE described in the embodiments of the present disclosure.

The instructions for performing the operations of the UE described in the embodiments of this disclosure may be stored on a non-volatile computer-readable storage medium on which they are recorded. The storage medium may be included in the memory 12. The instructions recorded on the storage medium may be executed by the processor 11 to perform the operation of the UE.

A second device 20 may implement the network functions described herein (e.g., AMF, SMF, N3IWF, etc.) or the operation of a base station. The functions of the network node or base station described herein may be processed by a processor 21. The operations of the network node or base station described herein may be stored in a memory 22 in the form of instructions/programs executable by the processor 21. The processor 21 may control the memory 22 and a transceiver 23, and execute the instructions/programs stored in the memory 22 to perform the operations of the network node or base station described in the embodiments of this disclosure.

Further, the instructions for performing the operations of the network node or base station described in the embodiments of this disclosure may be stored on a non-volatile computer-readable storage medium. The storage medium may be included in the memory 22. The instructions recorded on the storage medium may then be executed by the processor 21 to perform the operations of the network node or base station.

What is claimed is:

1. A method for a communication that supports Access Traffic Steering, Switching and Splitting (ATSSS) via a multi-access (MA)-packet data unit (PDU) session, the method performed by a wireless device and comprising:
registering with a 3rd Generation Partnership Project (3GPP) access;
registering with a non-3GPP access;
establishing an MA-PDU session over the 3GPP access and the non-3GPP access; and
transmitting a message in the MA-PDU session through the non-3GPP access, the message including supplementary information relating to a communication status between the wireless device and the 3GPP access.

2. The method of claim 1, wherein registering with the non-3GPP access includes:
selecting a Non-3GPP Interworking Function (N3IWF) over the non-3GPP access; and
obtaining a secure key for the N3IWF over the 3GPP access.

3. The method of claim 2, wherein the message is encapsulated based on the secure key.

4. The method of claim 2, wherein establishing the MA-PDU session over the 3GPP access and the non-3GPP access includes:
transmitting a PDU session establishment request message including a request type set to “MA-PDU request”; and
receiving a PDU session establishment accept message in response to the PDU session establishment request message, the PDU session establishment accept message including a ATSSS rule, the ATSSS rule including a steering mode indicating that the non-3GPP access is to be used for transmission of the supplementary information.

5. The method of claim 1, wherein the supplementary information includes information regarding whether the 3GPP access is unavailable.

6. The method of claim 5, wherein the supplementary information includes information regarding an unavailable time duration during which the 3GPP access is unavailable.

7. The method of claim 1, wherein the supplementary information includes information regarding a communication quality between the 3GPP access and the wireless device.

8. The method of claim 7, wherein the supplementary information includes information regarding a time duration during which the wireless device expects that the communication quality with the 3GPP access is lowered.

9. A device for supporting Access Traffic Steering, Switching and Splitting (ATSSS) via a multi-access (MA)-packet data unit (PDU) session, the device comprising:
a processor; and
a memory operatively coupled with the processor and configured to store instructions that, when executed by the processor, cause the device to perform functions comprising:
registering with a 3rd Generation Partnership Project (3GPP) access;
registering with a non-3GPP access;
establishing an MA-PDU session over the 3GPP access and the non-3GPP access; and
transmitting a message in the MA-PDU session through the non-3GPP access, the message including supplementary information relating to a communication status between the wireless device and the 3GPP access.

10. The device of claim 9, wherein registering with the non-3GPP access includes:
selecting a Non-3GPP Interworking Function (N3IWF) over the non-3GPP access; and
obtaining a secure key for the N3IWF over the 3GPP access.

11. The device of claim 10, wherein the message is encapsulated based on the secure key.

12. The device of claim 10, wherein establishing the MA-PDU session over the 3GPP access and the non-3GPP access includes:
transmitting a PDU session establishment request message including a request type set to “MA-PDU request”; and
receiving a PDU session establishment accept message in response to the PDU session establishment request message, the PDU session establishment accept message including a ATSSS rule, the ATSSS rule including a steering mode indicating that the non-3GPP access is to be used for transmission of the supplementary information.

13. The device of claim 9, wherein the supplementary information includes information regarding whether the 3GPP access is unavailable.

14. The device of claim 13, wherein the supplementary information includes information regarding an unavailable time duration during which the 3GPP access is unavailable.

15. The device of claim 9, wherein the supplementary information includes information regarding a communication quality between the 3GPP access and the wireless device.

16. The device of claim 15, wherein the supplementary information includes information regarding a time duration during which the wireless device expects that the communication quality with the 3GPP access is lowered.
